(19) United States
(12) Patent Application Publication
(10) Pub. No.: US 2026/0134341 A1
(43) Pub. Date: May 14, 2026

(54) DYNAMICALLY CONSTRUCTING A BACKGROUND DATASET FOR AN EXPLANATORY MODEL

(71) Applicant: Red Hat, Inc., Raleigh, NC (US)

(72) Inventors: Rui Miguel Cardoso De Freitas Machado Vieira, Newcastle Upon Tyne (GB); Robert Geada, Newcastle Upon Tyne (GB)

(21) Appl. No.: 18/948,062

(22) Filed: Nov. 14, 2024

(51) Int. Cl. G06N 20/00

(52) U.S. Cl. CPC G06N 20/00

(57) ABSTRACT

In one example, a system can receive a target input for a target model, update a summary statistic for a distribution based on the target input, and generate a set of input samples by sampling the distribution. The system can then provide the target input and the set of input samples as input to the target model, which can generate a target output based on the target input and a set of output samples based on the set of input samples. A background dataset can be updated based on the target output and the set of output samples. The updated background dataset, the target input, and the target output can then be input to an explanatory model, which can generate an explanation of why the target model generated the target output based on the target input. The explanation can be output to a user.

### TECHNICAL FIELD

The present disclosure relates generally to explanatory models used to explain the functionality of machine-learning models. More specifically, but not by way of limitation, this disclosure relates to dynamically constructing a background dataset for an explanatory model.

### BACKGROUND

The field of explainable artificial intelligence (XAI) seeks to investigate the functioning of black-box models, which are machine-learning models whose inner workings are either inaccessible or so complex as to be conventionally uninterpretable. Some common examples of such black-box models include deep neural networks and random forest classifiers. Explanations of these models may be necessary for regulatory reasons. For example, the General Data Protection Regulation (GDPR) entitles subjects of automated decisions the right to ask for an explanation of the decision-making process that led to those decisions. Furthermore, the behavior of these models may be investigated to ensure that they are compliant with regulations and business ethics, for example, to guarantee that they do not base their decisions on protected attributes such as race or gender.

### BRIEF DESCRIPTION OF THE DRAWINGS

FIG. 1 is a block diagram of an example of a process for dynamically constructing a background dataset for an explanatory model according to some aspects of the present disclosure.

FIG. 2 is a block diagram of an example of a system for dynamically constructing a background dataset for an explanatory model according to some aspects of the present disclosure.

FIG. 3 is a block diagram of an example of a computing system for dynamically constructing a background dataset for an explanatory model according to some aspects of the present disclosure.

FIG. 4 is a flowchart of an example of a process for dynamically constructing a background dataset for an explanatory model according to some aspects of the present disclosure.

FIG. 5 is a flowchart of an example of a process for generating a set of input samples according to some aspects of the present disclosure.

### DETAILED DESCRIPTION

Multiple kinds of explanatory models can be used to help explain the behavior of a black-box model (e.g., a neural network). One popular kind of explanatory model is a Shapley Additive explanations (SHAP) model. Explanatory models often rely on a background dataset to help generate their explanations. The background dataset is provided as one of the inputs to the explanatory model, after the training process for the explanatory model is complete. The background dataset is used by the explanatory model as a baseline or reference point against which the contributions of individual features provided as inputs to the black-box model can be measured. By removing or masking features and observing the changes in the black-box model's output over the background dataset, the explanatory model can quantify how each feature contributed to the final output from the black-box model.

Although explanatory models often require a background dataset for proper operation, there are many circumstances where a background dataset is not available. If a background dataset is not available, it may be possible to derive a background dataset from the training data used to train the black-box model. However, such training data is also typically not available. For instance, the end user of the black-box model may have little or no information about its internal operation, its training process, and its training data. In these scenarios, it may be impossible to use an explanatory model because there is no background dataset.

Some examples of the present disclosure can overcome one or more of the abovementioned problems by dynamically generating a background dataset for an explanatory model in circumstances where a background dataset is not already available. This can allow the explanatory model to be used those circumstances, when typically, that would not be possible due to lack of a background dataset. For instance, an end user of a black-box model can apply the techniques described herein to allow an explanatory model to be used with a black-box model, even though the user may lack access to the black-box model's training data and an existing background dataset. This can allow explanatory models to be used in new contexts that were previously foreclosed.

The techniques described herein can include an iterative process in which, during each iteration, a new datapoint is dynamically generated for the background dataset to build out the background dataset. After a maximum number of datapoints is reached for the background dataset, in each subsequent iteration of the iteration process, an existing datapoint in the background dataset is removed and replaced with a new datapoint. That way, there is never more than the maximum number of datapoints in the background dataset.

When the iterative process begins, the majority of the datapoints in the background dataset are derived by sampling a predefined distribution, such as a Gaussian distribution. Such datapoints can be referred to as synthetic datapoints, since they are generated based on synthetic samples from the distribution. With each subsequent iteration, a real datapoint is generated using the black-box model, and the background dataset is adjusted to include the real datapoint. In this way, over time, more real datapoints and fewer synthetic datapoints are included in the background dataset, leading to more accurate results. Eventually, the background dataset can consist of mostly (or only) real datapoints.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

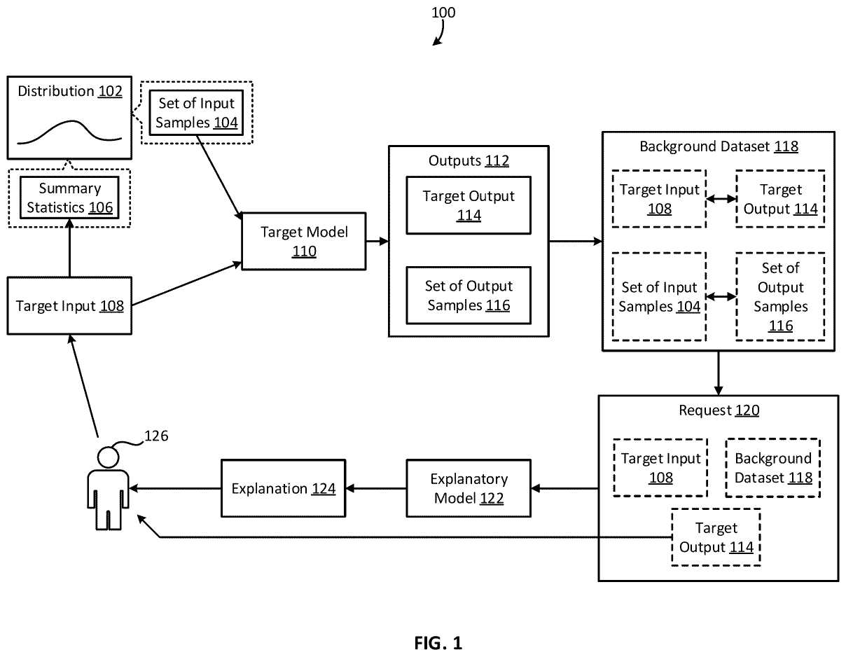

FIG. 1 is a block diagram of an example of an iterative process 100 for dynamically constructing a background dataset 118 for an explanatory model 122 according to some aspects of the present disclosure. The iterative process 100 can be implemented by a computer system.

Each iteration of the iterative process 100 begins with the computer system receiving a target input 108 intended for a target model 110. The target input 108 can be received from a user 126 who would like to use the target model 110 to generate a prediction (e.g., a forecast) or other output based on the target input 108. The target model 110 can be a black-box model with respect to the user 126, in the sense that the user 126 may have little or no information about its inner workings. In some examples, the target model 110 is a machine-learning model, such as a neural network, classifier, etc. The target model 110 may have previously undergone a training process before it was deployed on the computer system. In some scenarios, the training data may be unavailable to the user 126 and the computer system.

Based on the target input 108, the computer system can update one or more summary statistics 106 for a predefined distribution 102. The distribution 102 can be a Gaussian distribution, a Poisson distribution, a Binomial distribution, or another type of distribution. The summary statistics 106 can define the distribution 102. Examples of the summary statistics 106 can include a mean, a median, a mode, a variance, a standard deviation, a range, a minimum, and/or a maximum, depending on the type of distribution 102. The distribution 102 may have been previously generated prior to receiving the target input 108. During the first iteration of the process 100, the distribution 102 may be relatively vague. For example, the distribution 102 may be a vague Gaussian prior, with a mean of 0 and a covariance of I(10000). Then, over the course of numerous iterations, the distribution 102 is updated and becomes more finely tuned, as explained later.

After updating the summary statistics 106, the computer system can generate a set of input samples 104 based on the distribution 102. For example, the computer system can sample the distribution 102 a certain number of times to generate the set of input samples 104. The number of times in which the distribution 102 is sampled can change (e.g., decrease) in each iteration, as explained later. This can allow the size of the background dataset 118 to remain the same over the course of the iterative process.

The computer system can provide the target input 108 and the set of input samples 104 as input to the target model 110. The target model 110 can generate outputs 112 based on the inputs. For example, the target model 110 can generate a target output 114 based on the target input 108. The “target output” is the desired output that corresponds to the target input 108. The target model 110 can also generate a set of output samples based on the set of input samples 104, where each output sample corresponds to one of the input samples. Thus, if the target input and the set of input samples 104 collectively include one hundred total inputs, the target model 110 can generate one hundred total outputs 112, with a one-to-one mapping of inputs to outputs.

Based on the outputs 112, the computer system can generate (e.g., update) a background dataset 118. The background dataset 118 can include a mapping of the target input 108 to the target output 114, which can be considered a “real” datapoint because it is a real output based on a real input. The background dataset 118 can also include mappings of the input samples 104 to the output samples 116, each of which can be considered a “synthetic” datapoint because it is an output based on a synthetic input. At this stage, if this is the first iteration of the iterative process 100, the background dataset 118 can include a single real datapoint and many synthetic datapoints.

The computer system can generate a request 120 that includes the background dataset 118, the target input 108, and the target output 114. The computer system can then provide the request 120 as input to the explanatory model 122, which may include a SHAP algorithm. In response to receiving the request 120, the explanatory model 122 can generate an explanation 124 of why the target input 108 produced the target output 114. The explanation 124 can indicate how one or more features of the target input 108 each contributed to the target output 114. In some examples, the explanation 124 may be formatted as a text snippet that uses words to provide the explanation 124.

After generating the explanation 124, the computer system can provide the explanation 124 and/or the target output 114 to the user 126. Based on the explanation 124, the user 126 may be able to better understand why the target model 110 produced the target output 114 based on the target input 108.

This can complete to a single iteration of the iterative process. The above process can repeat each time the computer system receives a target input from a user (e.g., the same user 126 and/or a different user). Over time, as the process iterates, the number of real datapoints in the background dataset 118 can grow (and the number of synthetic datapoints in the background dataset 118 can decrease), which can result in a better background dataset 118 that yields more accurate explanations from the explanatory model 122. Eventually, the background dataset 118 can reach a steady state condition in which it mostly (or only) contains real datapoints and provides highly accurate results.

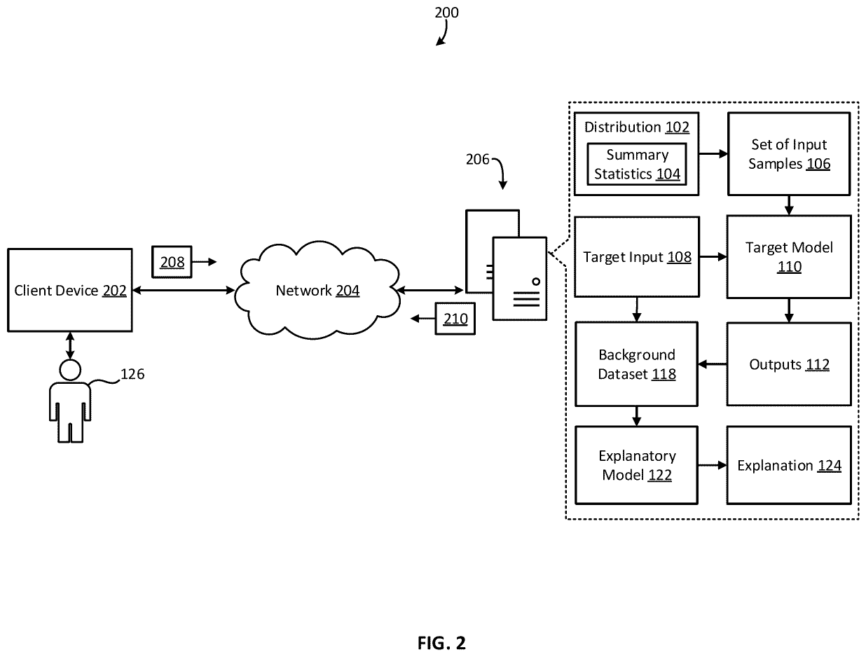

Turning now FIG. 2, shown is a block diagram of an example of a system 200 for dynamically constructing a background dataset 118 for an explanatory model 122 according to some aspects of the present disclosure. The system 200 includes a client device 202, such as a laptop computer, desktop computer, tablet, e-reader, smartphone, or wearable device. The client device 202 is in communication with a server system 206 via one or more networks 204, such as a local area network (LAN) or the Internet.

In this example, the client device 202 can transmit a communication 208 that includes a target input 108 to the server system 206. The server system 206 can then perform the process described above with respect to FIG. 1 to generate a target output 110 and a corresponding explanation 124, either or both of which can be transmitted to the client device 202 in another communication 210. The client device 202 may then display the target input 108, the target output 114, and/or the explanation to the user 126. This may be considered one iteration of the iterative process, which can be repeated any number of times. As the number of iterations increases, the background dataset 118 will gradually be updated to contain more real datapoints and fewer synthetic datapoints (e.g., until it only contains real datapoints).

For purposes of explaining additional aspects of the iterative process, the following notation will be used:
X is the input to the target model, which includes n individual features F₁ to Fₙ.
Xₜ is the input to the target model at time t.
N is a maximum number of real datapoints to include in the background dataset.
Sᵢ is a collection of m synthetic samples, taken from the distribution.
D is a number of additional diversity background samples to take from the distribution in each iteration.
B is the final background dataset, which can consist of N+D datapoints.
ŷₜ is the output value from the target model based on input Xₜ.
The target model is f, where f(Xₜ)=ŷₜ.

As one specific example, the target model (f) can predict the number of compute workloads (ŷₜ) that can be handled by a given compute node that has some attributes (X). Examples of the attributes (X) can include available processing power (F₁) and available memory (F₂). To produce meaningful SHAP explanations, the explanatory model 122 needs a background dataset (B), which includes a baseline of examples to compare against the compute node's attributes. Ideally, this should be a diverse set of examples that may typically be obtained from the training data of the target model 110. But if no such training data is available, the techniques described herein can be used to dynamically generate the background dataset (B), which can have a maximum of N real datapoints and D diversity datapoints. A diversity datapoint is a synthetic datapoint sampled from the distribution 102 to improve the diversity of the background dataset (B). In some examples, N can be selected by the user. In this example, N=200 and D=50. The distribution 102 can be a vague Gaussian distribution, with a mean (available processing power=0, available memory=0) and some large variance.

Upon the arrival of the first target input (e.g., at t=0), the server system 206 updates the summary statistics 106 for the distribution based on the first target input to account for this new data. Note that the first target input is not actually stored in the distribution nor is it actually part of the distribution 102, it is merely used to update the summary statistics 106 that define the characteristics of the distribution 102. Because N+D=250, and there is currently only one target input, the remaining 249 datapoints can be derived by sampling the distribution that many times. In other words, 249 samples can be taken of the distribution 102. Those 249 samples can constitute the set of input samples 104. The set of input samples 104, along with the target input 108, are then provided as inputs to the target model 110, which generates 250 corresponding outputs. The server system 206 can then generate the background dataset (B) based on those 250 inputs/outputs, which includes one “real” datapoint and 249 “synthetic” datapoints. The background dataset (B) can then be used with the explanatory model 122 to generate an explanation 124 associated with the first target input.

Upon the arrival of a second target input (e.g., at t=1), the above process can repeat. In this second iteration, the number of samples drawn from the distribution 102 can be decreased by one to take into account we now have two real inputs. That is, there may be 248 samples taken from the distribution 102 during this second iteration. As more iterations of the process occur, and the distribution 102 (its summary statistics 106) is repeatedly updated, the sampled values from the distribution 102 can start to better resemble real values, because they better reflect the actual distribution of the real data.

Eventually, the iterative process will repeat enough times to produce N real datapoints in the background dataset 118. For example, the iterative process can repeat 200 times, resulting in 200 real datapoints in the background dataset 118. From that point on, each time the process iterates, only D samples may be taken from the distribution 102 for diversity purposes. Additionally, each time the process iterates, an existing datapoint can be removed from the background dataset 118 and a new datapoint can be included in the background dataset 118, so that newer datapoints outweigh older datapoints. The server system 206 can randomly choose the existing datapoint to remove or, alternatively, may choose the existing datapoint according to a predefined selection criterion.

The iterative process can be generally summarized as follows:
1. Select a distribution, the maximum size N, and the diversity size D;
2. At time t, receive a target input Xₜ for a target model
3. Update the distribution (e.g., its summary statistics) based on Xₜ
4. Obtain D samples from the updated distribution: {S₁, . . . . S_{D}}
5. If t<N
   a. Obtain N-t samples from the updated distribution: {Sₜ, . . . . S_{N}}
   b. Generate model outputs: f(Xₜ), {f(Sₜ), . . . , f(S_{N})}, {f(S₁), . . . , f(S_{D})}
   c. Build background data as:

$$B = \{ ( {X}_{0} , f ( {X}_{0} ) ) , … , ( {X}_{t} , f ( {X}_{t} ) ) \} U \{ ( {S}_{t} , f ( {S}_{t} ) ) , … , ( {S}_{N} , f ( {S}_{N} ) ) \} U \{ ( {S}_{1} , f ( {S}_{1} ) ) , … , ( {S}_{D} , f ( {S}_{D} ) ) \}$$

6. If t≥N
   a. Discard an existing datapoint from the background dataset—e.g., at random in [0, N].
   b. Generate model outputs: f(Xₜ), {f(S₁), . . . , f(S_{D})}
   c. Insert a new datapoint into the background dataset (e.g., at the discarded position).
   d. Build background data as:

$$B = \{ ( {X}_{0} , f ( {X}_{0} ) , … , ( {X}_{t} , f ( {X}_{t} ) ) \} U \{ ( {S}_{1}^{′} , f ( {S}_{1}^{′} ) , … , ( {S}_{D}^{′} , f ( {S}_{D}^{′} ) ) \}$$

7. Use B and (Xₜ, f(Xₜ)) to calculate explanation (e.g., SHAP explanation) via explanatory model.
8. Go to step 2.

Through the above process, the server system 206 can dynamically generate a background dataset 118 from scratch and update the background dataset 118 over a series of iterations, such that real datapoints replace synthetic datapoints, and such that newer real datapoints replace older real datapoints, to thereby continually improve the accuracy of the background dataset 118.

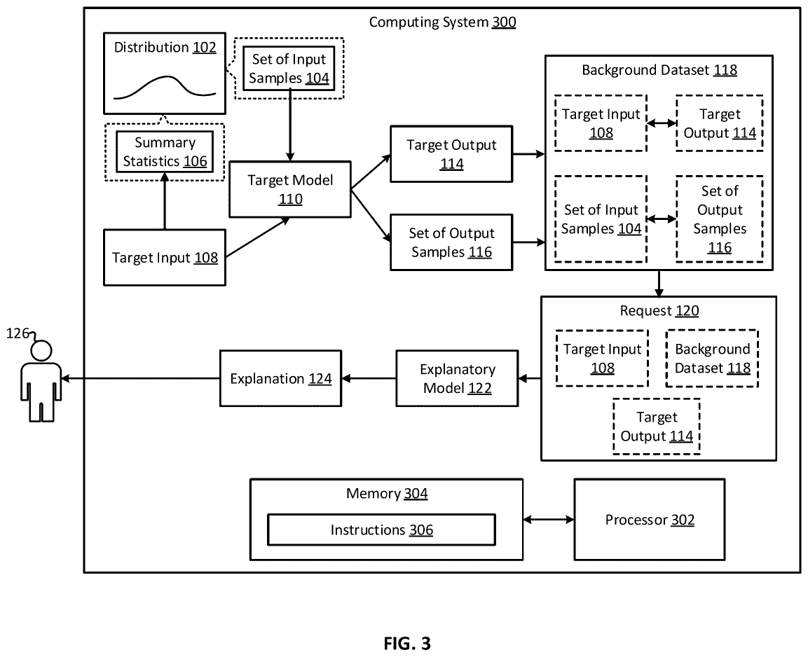

Turning now to FIG. 3, shown is a block diagram of an example of a computing system 300 for dynamically constructing a background dataset 118 for an explanatory model 122 according to some aspects of the present disclosure. As shown, the computing system 300 can include a processor 302 communicatively coupled to a memory 304 by a bus. The processor 302 can include one processing device or multiple processing devices. Non-limiting examples of the processor 302 include a Field-Programmable Gate Array (FPGA), an application-specific integrated circuit (ASIC), a microprocessor, or any combination of these. The processor 302 can execute instructions 306 stored in the memory 304 to perform operations, such as any of the operations described herein. In some examples, the instructions 306 can include processor-specific instructions generated by a compiler or an interpreter from code written in any suitable computer-programming language, such as C, C++, C#, Python, or Java.

The memory 304 can include one memory device or multiple memory devices. The memory 304 can be volatile or non-volatile, such that the memory 304 retains stored information when powered off. Non-limiting examples of the memory 304 include electrically erasable and programmable read-only memory (EEPROM), flash memory, or any other type of non-volatile memory. At least some of the memory device can include a non-transitory computer-readable medium from which the processor 302 can read the instructions 306. A computer-readable medium can include electronic, optical, magnetic, or other storage devices capable of providing the processor 302 with computer-readable instructions or other program code. Non-limiting examples of a computer-readable medium can include magnetic disks, memory chips, ROM, random-access memory (RAM), an ASIC, a configured processor, optical storage, or any other medium from which a computer processor can read the instructions 306.

In some examples, the processor 302 can execute the instructions 306 to perform operations. For example, the processor 302 can receive a target input 108 for a target model 110, update a summary statistic 106 for a distribution 102 based on the target input 108, and generate a set of input samples 104 by sampling the distribution 102. In some examples, the processor 302 can update multiple summary statistics for the distribution 102 based on the target input 108. Next, the processor 302 can provide the target input 108 and the set of input samples 104 as input to the target model 110. The target model 110 can be configured to generate a target output 114 based on the target input 108 and to generate a set of output samples 116 based on the set of input samples 104. The processor 302 can then update the background dataset 118 to include a mapping between the target input 108 and the target output 114, and to including mappings between the set of input samples 104 and the set of output samples 116. The processor 302 can next generate a request 120 that includes the updated background dataset 118, the target input 108, and the target output 114. The request 120 can be any suitable input data structure intended for the explanatory model 122. The processor 302 can provide the request as input to an explanatory model 122, which can be configured to respond to the request 120 by generating an explanation 124 of why the target model 110 generated the target output 114 based on the target input 108. The processor 302 can then output the explanation 124 to a user 126. This may involve, for example, transmitting the explanation 124 to a client device of the user 126.

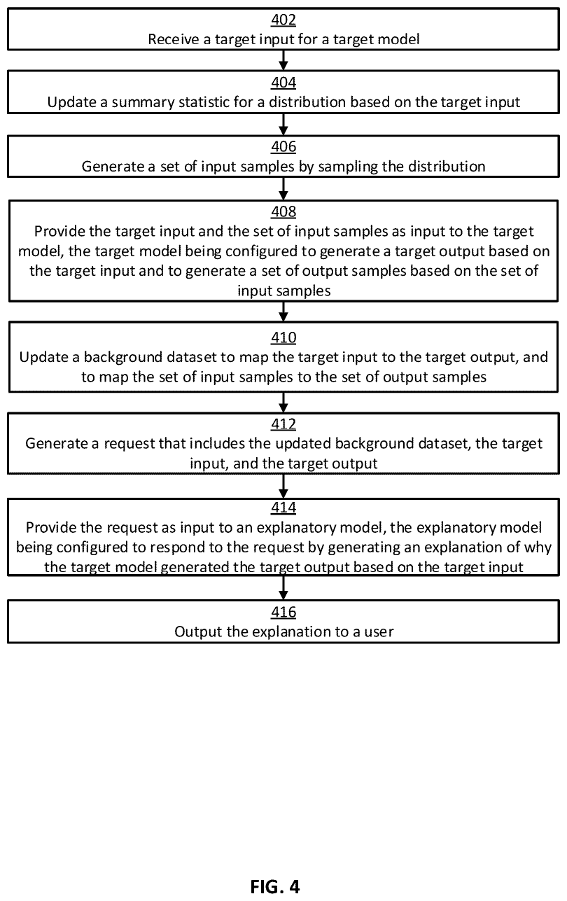

Turning now to FIG. 4, shown is a flowchart of an example of a process for dynamically constructing a background dataset 118 for an explanatory model 122 according to some aspects of the present disclosure. Other examples may include more operations, fewer operations, different operations, or a different sequence of operations than is shown in FIG. 4. The steps of FIG. 4 are described below with reference to the components of FIG. 3 described above.

In block 402, the processor 302 receives a target input 108 for a target model 110. The processor 302 can receive the target input 108 from a user 126. For example, the user 126 can operate a client device to transmit the target input 108 to the processor 302. Alternatively, the processor 302 can receive the target input 108 from another source, such as a database.

In block 404, the processor 302 updates a summary statistic 106 for a distribution 102 based on the target input 108. This may involve recomputing the summary statistic 106, which can be a numerical value, based on the target input 108, which can also be a numerical value.

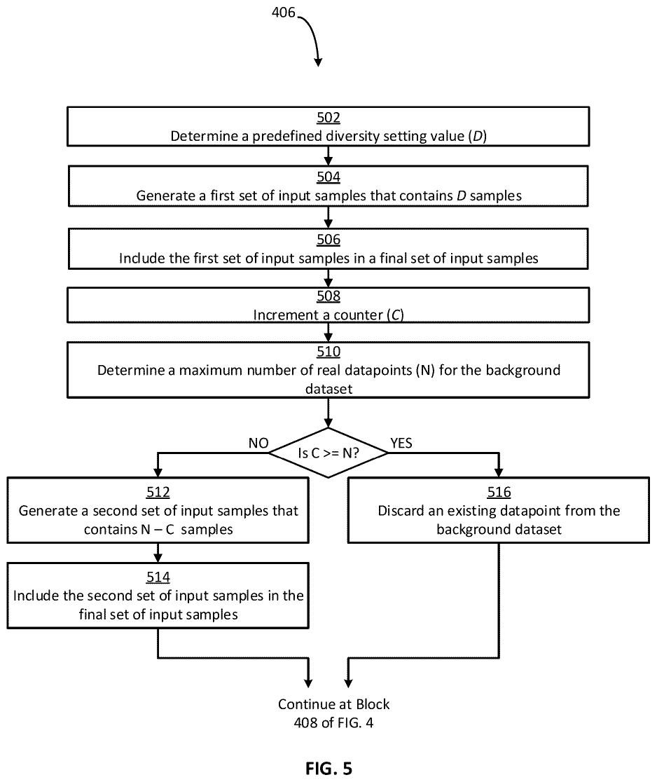

In block 406, the processor 302 generates a set of input samples 104 by sampling the distribution 102. The set of input samples 104 can include N-t samples drawn from the distribution 102, D diversity samples drawn from the distribution, or both. One example of a process for generating of the set of samples 104 is described in greater detail later with respect to FIG. 5.

In block 408, the processor 302 provides the target input 108 and the set of input samples 104 as input to the target model 110. The target model 110 is configured to generate a target output 114 based on the target input 108 and to generate a set of output samples 116 based on the set of input samples 104. One example of the target model 110 can be a time-series forecasting model, where the inputs and outputs may be numerical values.

In block 410, the processor 302 updates the background dataset 118 to map the target input 108 to the target output 114, and to map the set of input samples 104 to the set of output samples 116. For example, the processor 302 can include a new datapoint in the background dataset 118 that correlates the target input 108 to the target output 114. The processor 302 can also include additional new datapoints in the background dataset 118 that correlate the set of input samples 104 to the set of output samples 116. Each datapoint can be an {input, output} pair.

In block 412, the processor 302 generates a request 120 that includes the updated background dataset 118, the target input 108, and the target output 114. The request 120 may be in a vector format or another format.

In block 414, the processor 302 provides the request as input to an explanatory model 122. The explanatory model 122 is configured to respond to the request 120 by generating an explanation 124 of why the target model 110 generated the target output 114 based on the target input 108. For example, the explanation 124 can indicate that some features of the target input 108 contributed more heavily or less heavily to the target output 114 than others.

In block 416, the processor 302 outputs the explanation 124 to a user 126. This may involve transmitting the explanation 124 to a client device of the user 126 or displaying the explanation 124 on a display device to the user 126.

Turning now to FIG. 5, shown is a flowchart of an example of a process for generating a set of input samples 104 according to some aspects of the present disclosure. Other examples may include more operations, fewer operations, different operations, or a different sequence of operations than is shown in FIG. 5. Some or all of the steps of FIG. 5 can be considered sub-steps of block 406 of FIG. 4, described above.

In block 502, the processor 302 determines a predefined diversity setting value (D). The diversity setting value (D) may have previously been selected by a user and stored in memory 304 as part of a configuration process. The processor 302 can thus retrieve the diversity setting value (D) from memory 304.

In block 504, the processor 302 generates a first set of input samples that contains D samples. This may be achieved by sampling the distribution 102 D times.

In block 506, the processor 302 includes in the first set of input samples in a final set of input samples. The final set of input samples can serve as the “set of samples” in block 406 of FIG. 4.

In block 508, the processor 302 increments a counter (C). The counter can begin at zero and be incremented in each iteration of the iterative process. Thus, the counter value (C) may correspond to t in some examples.

In block 510, the processor 302 determines a maximum number of real datapoints (N) to include the background dataset 118. The maximum number (N) may have previously been selected by a user and stored in memory 304 as part of a configuration process. The processor 302 can thus retrieve the maximum number (N) from memory 304.

In block 512, the processor 302 determines whether the counter value (C) is greater than or equal to the maximum number (N). If not, the process can proceed to block 512, where the processor 302 generates a second set of input samples that contains N—C samples. This may be achieved by sampling the distribution 102 N—C times. In block 514, the second set of input samples are included in the final set of input samples.

On the other hand, if the counter value (C) is greater than or equal to the maximum number (N), the process can proceed to block 516. At block 516, the processor 302 can discard an existing datapoint from the background dataset 118.

The process may then continue at block 408 of FIG. 4. If block 516 was executed because C≥N, then at block 410 the processor 302 may insert a new datapoint (e.g., a new real datapoint that maps the target input 108 to the target output 114) into the same position in the background dataset 118 as the old datapoint that was previously discarded in block 516.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

1. A non-transitory computer-readable medium comprising program code that is executable by one or more processors to perform operations, wherein the operations include an iterative process, and wherein each iteration of the iterative process involves:
receiving a target input for a target model;
updating a summary statistic for a distribution based on the target input;
generating a set of input samples by sampling the distribution;
providing the target input and the set of input samples as input to the target model, the target model being configured to generate a target output based on the target input and to generate a set of output samples based on the set of input samples;
updating a background dataset to map the target input to the target output, and to map the set of input samples to the set of output samples;
generating a request that includes the updated background dataset, the target input, and the target output;
providing the request as input to an explanatory model, the explanatory model being configured to respond to the request by generating an explanation of why the target model generated the target output based on the target input; and
outputting the explanation to a user.

2. The non-transitory computer-readable medium of claim 1, wherein each iteration of the iterative process for includes:
incrementing a counter value; and
determining whether the counter value meets or exceeds a maximum number of real datapoints.

3. The non-transitory computer-readable medium of claim 2, wherein the operations further comprise:
in response to determining that the counter value meets or exceeds the maximum number of real datapoints, updating the background dataset by:
discarding an existing datapoint from the background dataset; and
adding a new datapoint to the background dataset, wherein the new datapoint corresponds to the target input.

4. The non-transitory computer-readable medium of claim 3, wherein the operations further comprise randomly selecting the existing datapoint to be discarded from the background dataset.

5. The non-transitory computer-readable medium of claim 2, wherein the operations further comprise:
sampling the distribution D times to generate a set of diversity samples, wherein D corresponds to a predefined diversity setting value; and
including the set of diversity samples in the set of input samples.

6. The non-transitory computer-readable medium of claim 2, wherein the operations further comprise:
in response to determining that the counter value is below the maximum number of real datapoints:
sampling the distribution X times to generate a first set of input samples, wherein X corresponds to a difference between the counter value and the maximum number of real datapoints; and
including the first set of input samples in the set of input samples.

7. The non-transitory computer-readable medium of claim 6, wherein the operations further comprise:
sampling the distribution D times to generate a second set of input samples, wherein D corresponds to a predefined diversity setting value; and
including the second set of input samples in the set of input samples.

8. The non-transitory computer-readable medium of claim 1, wherein the target model is a machine-learning model.

9. The non-transitory computer-readable medium of claim 1, wherein the explanatory model includes a SHapley Additive explanations (SHAP) model.

10. The non-transitory computer-readable medium of claim 1, wherein the distribution is a Gaussian distribution.

11. The non-transitory computer-readable medium of claim 1, wherein the summary statistic includes a mean, a median, a mode, a variance, a standard deviation, a range, a minimum, or a maximum.

12. A method comprising:
receiving, by one or more processors, a target input for a target model;
updating, by the one or more processors, a summary statistic for a distribution based on the target input;
generating, by the one or more processors, a set of input samples by sampling the distribution;
providing, by the one or more processors, the target input and the set of input samples as input to the target model, the target model being configured to generate a target output based on the target input and to generate a set of output samples based on the set of input samples;
updating, by the one or more processors, background dataset to map the target input to the target output, and to map the set of input samples to the set of output samples;
generating, by the one or more processors, a request that includes the updated background dataset, the target input, and the target output;
providing, by the one or more processors, the request as input to an explanatory model, the explanatory model being configured to respond to the request by generating an explanation of why the target model generated the target output based on the target input; and
outputting, by the one or more processors, the explanation to a user.

13. The method of claim 12, further comprising:
incrementing a counter value; and
determining whether the counter value meets or exceeds a maximum number of real datapoints.

14. The method of claim 13, further comprising:
in response to determining that the counter value meets or exceeds the maximum number of real datapoints, updating the background dataset by:
discarding an existing datapoint from the background dataset; and
adding a new datapoint to the background dataset, wherein the new datapoint corresponds to the target input.

15. The method of claim 13, further comprising:
generating the set of input samples by sampling the distribution D times, wherein D corresponds to a predefined diversity setting value.

16. The method of claim 13, further comprising:
in response to determining that the counter value is below the maximum number of real datapoints:
generating a first set of input samples by sampling the distribution X times, wherein X corresponds to a difference between the counter value and the maximum number of real datapoints; and
configuring the set of input samples to include the first set of input samples.

17. The method of claim 16, further comprising:
generating a second set of input samples by sampling the distribution D times, wherein D corresponds to a predefined diversity setting value; and
configuring the set of input samples to include the first set of input samples and the second set of input samples.

18. The method of claim 12, wherein the target model is a machine-learning model, and wherein the explanatory model includes a SHapley Additive explanations (SHAP) model.

19. The method of claim 12, wherein the summary statistic includes a mean, a median, a mode, a variance, a standard deviation, a range, a minimum, or a maximum.

20. A system comprising:
one or more processors; and
one or more memories storing instructions that are executable by the one or more processors for causing the one or more processors to perform operations including:
receiving a target input for a target model;
updating a summary statistic for a distribution based on the target input;
generating a set of input samples by sampling the distribution;
providing the target input and the set of input samples as input to the target model, the target model being configured to generate a target output based on the target input and to generate a set of output samples based on the set of input samples;
updating a background dataset to map the target input to the target output, and to map the set of input samples to the set of output samples;
generating a request that includes the updated background dataset, the target input, and the target output;
providing the request as input to an explanatory model, the explanatory model being configured to respond to the request by generating an explanation of why the target model generated the target output based on the target input; and
outputting the explanation to a user.
